(19) United States
(12) Patent Application Publication
(10) Pub. No.: US 2013/0043108 A1
(43) Pub. Date: Feb. 21, 2013

(54) CONVEYOR-BELT COOLING APPARATUS OF METALLURGICAL FURNACE

(71) Applicant: WEN YUAN CHANG, MIAOLI COUNTY 351 (TW)

(72) Inventor: WEN YUAN CHANG, MIAOLI COUNTY 351 (TW)

(21) Appl. No.: 13/210,528

(22) Filed: Aug. 16, 2011

(51) Int. Cl. B65G 13/02; F28D 15/00

(52) U.S. Cl. 198/780

(57) ABSTRACT

A conveyor-belt cooling apparatus includes primary frames, bearings respectively disposed on the primary frames, pivot shafts, inner tubes and at least one refrigerant pipeline assembly. Two ends of the pivot shaft combined in the corresponding bearings are disposed on the primary frames. The inner tubes are penetrated through and disposed in each of the pivot shafts so that the inner tubes and the pivot shaft form a relative sliding therebetween. The refrigerant pipeline assembly is assembled by refrigerant conduits and one refrigerant engaging pipe. The inner tubes are connected by the refrigerant engaging pipe therebetween to form the refrigerant engaging pipe with a serial connection status, and the refrigerant conduits are engaged to the serially connected inner tubes, absorbing heat flux of the pivot shafts by the inner tubes and guiding a refrigerant in and out of the inner tubes by the refrigerant conduits to form a heat-dissipative circulation.

### BACKGROUND OF THE INVENTION

1. Field of the Invention

The present invention relates to a conveyor-belt cooling apparatus of a metallurgical furnace, and in particular relates to a conveyor-belt cooling apparatus providing an independent heat-dissipative system to reduce self-component temperature and capable of being operated in a high temperature conveying environment.

2. Description of the Related Art

In conventional conveyor-belt structures suitable for high temperature environments, “ENDLESS CONVEYOR BELT FOR USE IN A HIGH TEMPERATURE ENVIRONMENT” of Taiwan Invention Patent Publication No. 196192, for example, discloses a very simple linking structure. However, a conveyor belt provided in '192 case provides a structural design much different from that of conventional one and hard to be accepted by the related industries, and the endless conveyor belt of '192 case provided with an inferior driving force is merely suitable for light-load application environment. Further, because the endless conveyor belt of '192 case does not provide with temperature-reducing or heat-dissipative design, heat flux transferred from the endless conveyor belt operated in a high temperature condition might shorten the life span of the nearby components.

Thus, it is essential to provide an improved belt conveyor structure, based on the design of the conventional belt conveyor structure, with an increased working ability in heat-dissipative or high temperature environment to meet the requirements of heavy load or high temperature transmission.

### BRIEF SUMMARY OF THE INVENTION

In view of this, the invention provides a conveyor-belt cooling apparatus of a metallurgical furnace to overcome the disadvantages of the conventional belt conveyor structure.

The main purpose of the present invention is to provide a conveyor-belt cooling apparatus of a metallurgical furnace with an independent heat-dissipative system, capable of introducing an external circulated refrigerant to reduce self-component temperature and assure that the components can be normally operated in a high temperature conveying environment.

Another purpose of the present invention is to provide a conveyor-belt cooling apparatus of a metallurgical furnace with a high temperature resistance structure, to suitably operate in a high temperature conveying environment.

To attain the purposes and effects above, the technical means adopted by the present invention comprises two juxtaposedly extended primary frames, a plurality of corresponding bearings respectively disposed on the two primary frames, a plurality of pivot shafts, a plurality of inner tubes and at least one refrigerant pipeline assembly. The pivot shafts comprise hollow tubular-shaped bodies, and two ends of each of the pivot shafts respectively combined in the corresponding bearings disposed on the two primary frames. The inner tubes are respectively penetrated through and disposed in each of the pivot shafts so that each of the inner tubes and the corresponding pivot shaft of being circumferentially located form a close contact to have a relative sliding therebetween, and one end of each of the inner tubes includes a to-be-connected portion. The refrigerant pipeline assembly is combined with the to-be-connected portion of the inner tube to guide a refrigerant passing though each of the inner tubes to form a heat-dissipative circulation.

According to the above structure, the refrigerant pipeline assembly is assembled by two refrigerant conduits and at least one refrigerant engaging pipe, each of the two refrigerant conduits has one end including a first connecting element connectable to the to-be-connected portions of the inner tubes, and the refrigerant engaging pipe has at least one end including a second connecting element connectable to the to-be-connected portions of the inner tubes, so that the inner tubes are connected in series by the refrigerant engaging pipe therebetween, and the two refrigerant conduits are engaged to the ends of the serially connected inner tubes via the first connecting elements.

According to the above structure, load wheels of being synchronically pivoted and linked are disposed at an outer circumferential side of the pivot shaft.

According to the above structure, an outer circumferential side of at least one end of the pivot shaft is connected to a transmission element capable of receiving an external power to rotatably link the pivot shaft, and the transmission element is a gear.

According to the above structure, the transmission element is connected to an external power source via at least one engaging element, and the engaging element is a gear.

According to the above structure, two ends of the inner tube include the to-be-connected portions outwardly exposed from the pivot shaft and capable of being connected to the first connecting element. The to-be-connected portion of the inner tube is an outer thread, and the first connecting element and the second connecting element are screw caps engaged to the ends of the refrigerant conduits and the refrigerant engaging pipe.

According to the above structure, the bearing is fixed on the primary frame via a bearing seat.

According to the above structure, a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a structural exploded view of the invention;

FIG. 2 is a schematic view showing an integral assembly of the invention;

FIG. 3 is a sectional view showing an engaging portion of an inner tubes and a refrigerant pipeline assembly of the invention;

FIG. 4 is a view showing an exemplary embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

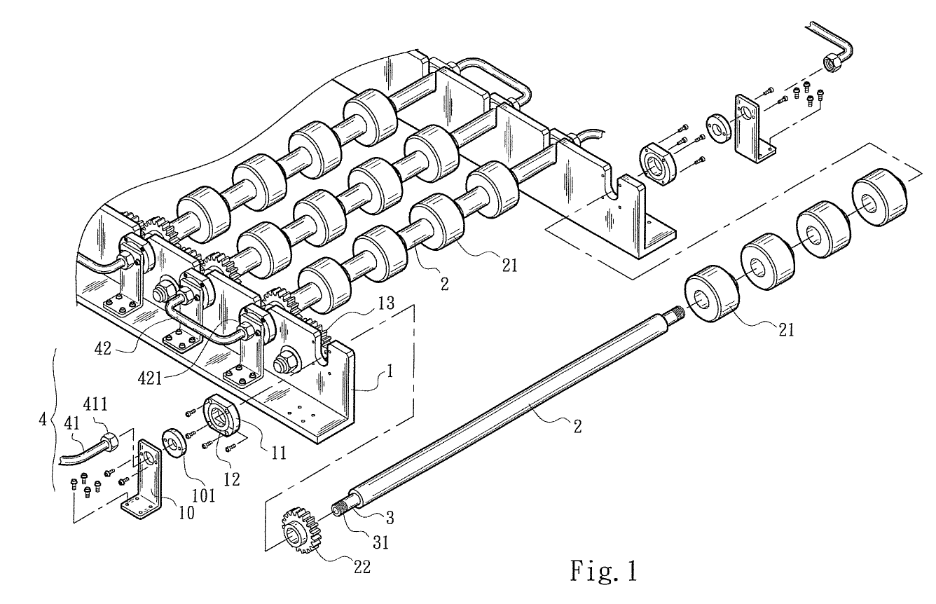

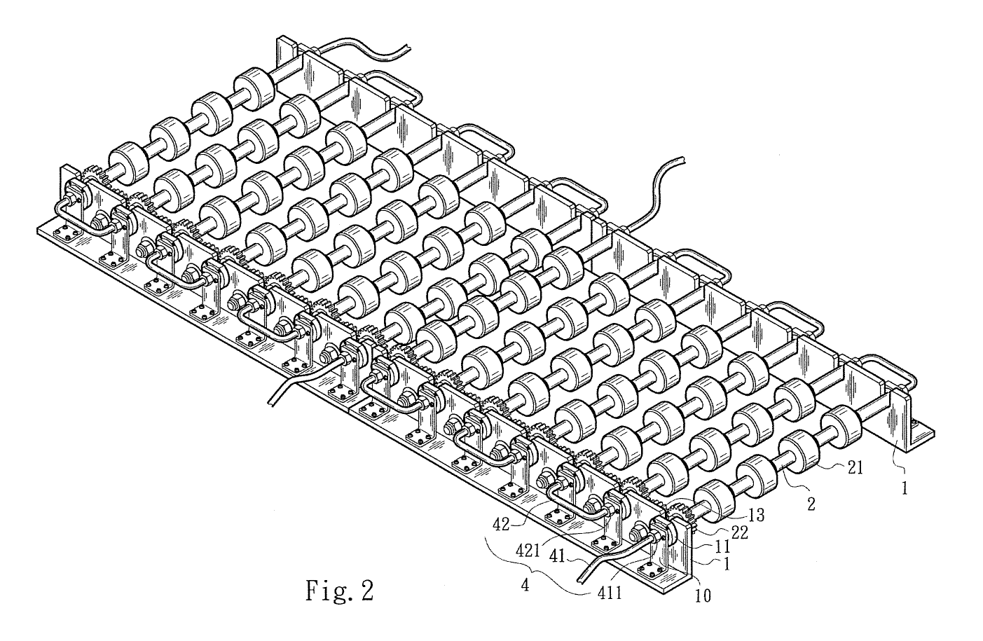

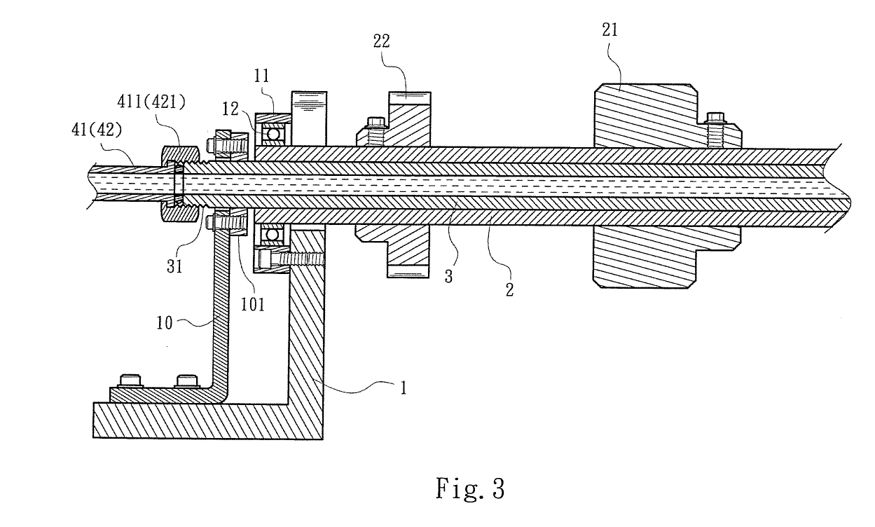

Referring to FIGS. 1, 2 and 3, a conveyor-belt cooling apparatus of a metallurgical furnace of the invention mainly comprises two primary frames 1 of being juxtaposedly extended and in parallel, a plurality of pivot shafts 2, a plurality of inner tubes 3 and a refrigerant pipeline assembly 4. The pivot shaft 2 is a hollow tubular-shaped body. A plurality of bearing seats 11 provided with bearings 12 thereon are disposed on the respective primary frames 1. A plurality of secondary frames 10 corresponding to the bearing seats 11 are respectively disposed outside next to the two primary frames 1, and a plurality of annular jackets 101 corresponding to the respective bearings 12 are respectively disposed on each of the secondary frames 10. Two ends of the pivot shaft 2 are respectively connected in the corresponding bearings 12 disposed on the two primary frames 1. A plurality of load wheels 21 of being synchronically pivoted and linked and at least one transmission element 22 are disposed at an outer circumferential side of the pivot shaft 2. The transmission element 22 can be a gear or a similar element capable of transmitting power. The transmission element 22 connected to an engaging element 13 receives an external power source (not shown in Figs.) via the engaging element 13, so that the pivot shaft 2 rotates the load wheels 21 to keep an object placed thereon in a sliding transmission status. The engaging element 13 can be a gear pivoted on the primary frame 1 or a similar element capable of transmitting power. In actual applications, the external power source can be generated from a motor to drive the engaging element 13 via a chain or a gear, to link the transmission element 22 for rotation. The inner tubes 3 are respectively penetrated through and disposed in each of the pivot shafts 2 so that each of the inner tubes 3 has a close contact to the corresponding pivot shaft 2 located at the outer circumferential side thereof to provide a relative sliding therebetween, and two ends of the inner tube 3 including to-be-connected portions 31 are outwardly exposed from the pivot shaft 2 and capable of penetrating through the bearings 12 and the annular jackets 101, respectively. The to-be-connected portion 31 of the inner tube 3 can be an outer thread. The refrigerant pipeline assembly 4, assembled by two refrigerant conduits 41 and at least one refrigerant engaging pipe 42, is combined with the to-be-connected portion 31 of the inner tube 3 to guide a refrigerant passing though each of the inner tubes 3 to form a heat-dissipative circulation. Each of the two refrigerant conduits 41 of the refrigerant pipeline assembly 4 has one end including a first connecting element 411 connectable to the to-be-connected portions 31 of the inner tubes 3, and the refrigerant engaging pipe 42 of the refrigerant pipeline assembly 4 has ends including second connecting elements 421 connectable to the to-be-connected portions 31 of the inner tubes 3. The first connecting element 411 and the second connecting element 421 are screw caps provided with washers therein. The inner tubes 3 are connected in series by the refrigerant engaging pipe 42 therebetween to form the refrigerant engaging pipe 42 with a serial connection status at two ends thereof, and the two refrigerant conduits 41 are engaged to the two ends of the serially connected inner tubes 3 via the first connecting elements 411. An external refrigerant transmitted into one inner tube 3 via one of the refrigerant conduits 41 passes through the other connected inner tubes 3 via the refrigerant engaging pipes 42 therebetween, and finally the refrigerant is expelled via the other refrigerant conduit 41, thereby forming a circulation cooling pipeline.

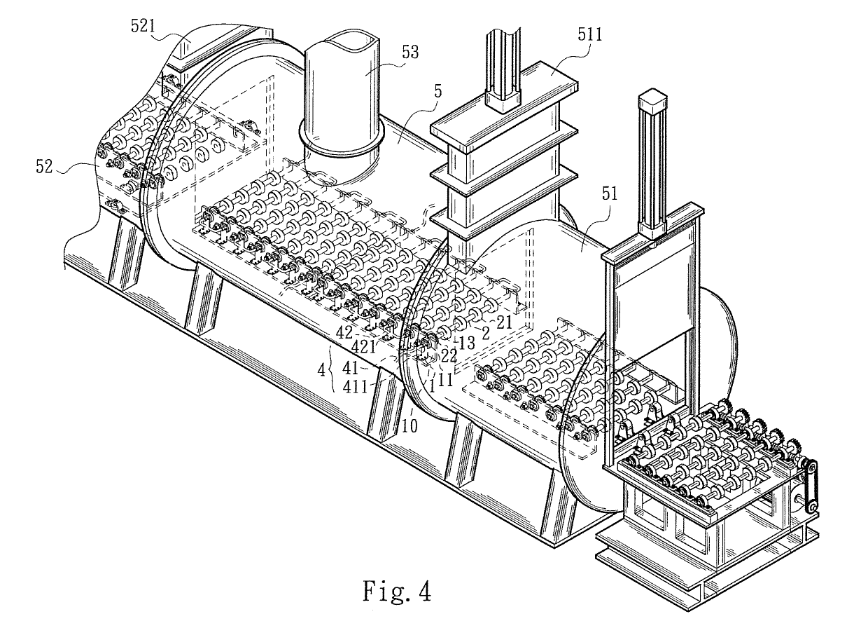

Referring to FIG. 4, in the actual applications, the conveyor-belt cooling apparatus of the invention can be disposed in a load room 5 of a separative reduction or metallurgical device. An input opening and an output opening are respectively provided at two sides of the load room 5, and an out-feed channel 53 provided on the top side of the load room 5 is upwardly connected to a reduction or metallurgical furnace (not shown in FIGS.). A preheated room 51 provided with a temperature-rising device therein is connected to the input opening of the load room 5 via a first load gate 511, and a cooling room 52 provided with a temperature-reducing device therein is connected to the output opening of the load room 5 via a second load gate 521. In operation, when a load container in the preheated room 51 is heated to a suitable temperature, the first load gate 511 is opened for entering the load container into the load room 5, and the load wheels 21 driven by the pivot shafts 2 are utilized to transmit the load container to a predetermined load position, so that a high temperature treated material in the reduction or metallurgical furnace is fallen into the load container located in the load room 5 via the out-feed channel 53. At this moment, the temperature of the interior of the load room 5 and the load container is very high and heat flux transferred therefrom is conducted to the refrigerant of the inner tubes 3 via the pivot shafts 2, so that heat flux can be efficiently expelled by the flow of the refrigerant, to keep the pivot shafts 2, the inner tubes 3 and the load wheels 21 to be functionally operated at a suitable low temperature and to eliminate possible thermal malfunctions and damages on these components. The second load gate 521 is then opened for entering the load container loaded with the material into the cooling room 52 for temperature-reducing and cooling processes.

In summary, the conveyor-belt cooling apparatus of the metallurgical furnace of the invention can have novel and progressive effects of reducing component temperature and being suitable for operation in a high temperature conveying environment. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A conveyor-belt cooling apparatus of a metallurgical furnace, at least comprising:
two juxtaposedly extended primary frames and a plurality of corresponding bearings respectively disposed on the two primary frames;
a plurality of pivot shafts comprising hollow tubular-shaped bodies, two ends of each of the pivot shafts respectively combined in the corresponding bearings disposed on the two primary frames;
a plurality of inner tubes respectively penetrated through and disposed in each of the pivot shafts so that each of the inner tubes and the corresponding pivot shaft of being circumferentially located form a close contact to have a relative sliding therebetween, one end of each of the inner tubes including a to-be-connected portion; and
at least one refrigerant pipeline assembly combined with the to-be-connected portion of the inner tube to guide a refrigerant passing though each of the inner tubes to form a heat-dissipative circulation.

2. The conveyor-belt cooling apparatus of the metallurgical furnace as claimed in claim 1, wherein the refrigerant pipeline assembly is assembled by two refrigerant conduits and at least one refrigerant engaging pipe, each of the two refrigerant conduits has at least one end including a first connecting element connectable to the to-be-connected portions of the inner tubes, and the refrigerant engaging pipe has at least one end including a second connecting element connectable to the to-be-connected portions of the inner tubes, so that the inner tubes are connected in series by the refrigerant engaging pipe therebetween, and the two refrigerant conduits are engaged to the ends of the serially connected inner tubes via the first connecting elements.

3. The conveyor-belt cooling apparatus of the metallurgical furnace as claimed in claim 1, wherein a plurality of load wheels of being synchronically pivoted and

4. The conveyor-belt cooling apparatus of the metallurgical furnace as claimed in claim 2, wherein a plurality of load wheels of being synchronically pivoted and linked are disposed at an outer circumferential side of the pivot shaft.

5. The conveyor-belt cooling apparatus of the metallurgical furnace as claimed in claim 1, wherein an outer circumferential side of at least one end of the pivot shaft is connected to a transmission element capable of receiving an external power to rotatably link the pivot shaft.

6. The conveyor-belt cooling apparatus of the metallurgical furnace as claimed in claim 2, wherein an outer circumferential side of at least one end of the pivot shaft is connected to a transmission element capable of receiving an external power to rotatably link the pivot shaft.

7. The conveyor-belt cooling apparatus of the metallurgical furnace as claimed in claim 3, wherein an outer circumferential side of at least one end of the pivot shaft is connected to a transmission element capable of receiving an external power to rotatably link the pivot shaft.

8. The conveyor-belt cooling apparatus of the metallurgical furnace as claimed in claim 5, wherein the transmission element is connected to an external power source via at least one engaging element.

9. The conveyor-belt cooling apparatus of the metallurgical furnace as claimed in claim 8, wherein the transmission element and the engaging element are gears.

10. The conveyor-belt cooling apparatus of the metallurgical furnace as claimed in claim 1, wherein two ends of the inner tube include the to-be-connected portions outwardly exposed from the pivot shaft

11. The conveyor-belt cooling apparatus of the metallurgical furnace as claimed in claim 2, wherein two ends of the inner tube include the to-be-connected portions outwardly exposed from the pivot shaft.

12. The conveyor-belt cooling apparatus of the metallurgical furnace as claimed in claim 3, wherein two ends of the inner tube include the to-be-connected portions outwardly exposed from the pivot shaft.

13. The conveyor-belt cooling apparatus of the metallurgical furnace as claimed in claim 5, wherein two ends of the inner tube include the to-be-connected portions outwardly exposed from the pivot shaft.

14. The conveyor-belt cooling apparatus of the metallurgical furnace as claimed in claim 10, wherein the to-be-connected portion of the inner tube is an outer thread, and the first connecting element and the second connecting element are screw caps engaged to the ends of the refrigerant conduits and the refrigerant engaging pipe.

15. The conveyor-belt cooling apparatus of the metallurgical furnace as claimed in claim 11, wherein the to-be-connected portion of the inner tube comprise an outer thread, and the first connecting element and the second connecting element are screw caps engaged to the ends of the refrigerant conduits and the refrigerant engaging pipe.

16. The conveyor-belt cooling apparatus of the metallurgical furnace as claimed in claim 12, wherein the to-be-connected portion of the inner tube comprise an outer thread, and the first connecting element and the second connecting element are screw caps engaged to the ends of the refrigerant conduits and the refrigerant engaging pipe.

17. The conveyor-belt cooling apparatus of the metallurgical furnace as claimed in claim 13, wherein the to-be-connected portion of the inner tube comprise an outer thread, and the first connecting element and the second connecting element are screw caps engaged to the ends of the refrigerant conduits and the refrigerant engaging pipe.

18. The conveyor-belt cooling apparatus of the metallurgical furnace as claimed in claim 1, wherein the bearing is fixed on the primary frame via a bearing seat.

19. The conveyor-belt cooling apparatus of the metallurgical furnace as claimed in claim 2, wherein the bearing is fixed on the primary frame via a bearing seat.

20. The conveyor-belt cooling apparatus of the metallurgical furnace as claimed in claim 3, wherein the bearing is fixed on the primary frame via a bearing seat.

21. The conveyor-belt cooling apparatus of the metallurgical furnace as claimed in claim 5, wherein the bearing is fixed on the primary frame via a bearing seat.

22. The conveyor-belt cooling apparatus of the metallurgical furnace as claimed in claim 10, wherein the bearing is fixed on the primary frame via a bearing seat.

23. The conveyor-belt cooling apparatus of the metallurgical furnace as claimed in claim 11, wherein the bearing is fixed on the primary frame via a bearing seat.

24. The conveyor-belt cooling apparatus of the metallurgical furnace as claimed in claim 1, wherein a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.

25. The conveyor-belt cooling apparatus of the metallurgical furnace as claimed in claim 2, wherein a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.

26. The conveyor-belt cooling apparatus of the metallurgical furnace as claimed in claim 3, wherein a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.

27. The conveyor-belt cooling apparatus of the metallurgical furnace as claimed in claim 5, wherein a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.

28. The conveyor-belt cooling apparatus of the metallurgical furnace as claimed in claim 10, wherein a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.

29. The conveyor-belt cooling apparatus of the metallurgical furnace as claimed in claim 11, wherein a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.

30. The conveyor-belt cooling apparatus of the metallurgical furnace as claimed in claim 18, wherein a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.

31. The conveyor-belt cooling apparatus of the metallurgical furnace as claimed in claim 19, wherein a plurality of secondary frames are respectively disposed outside next to the two primary frames, a plurality of annular jackets respectively corresponding to each of the bearings are respectively disposed on each of the secondary frames, and the two ends of the pivot shaft respectively penetrating through the annular jackets are connected to the refrigerant conduit and the refrigerant engaging pipe.
